(19) United States
(12) Patent Application Publication
(10) Pub. No.: US 2008/0274816 A1
(43) Pub. Date: Nov. 6, 2008

(54) Non-helical, multiple compound element, true torsion system

(76) Inventor: W. Thomas McClellan, Fort Lauderdale, FL (US)

Correspondence Address: LERNER GREENBERG STEMER LLP, P O BOX 2480, HOLLYWOOD, FL, 33022-2480, US

(21) Appl. No.: 11/800,499

(22) Filed: May 4, 2007

(51) Int. Cl. F16F 15/121

(52) U.S. Cl. 464/68.2; 16/75; 267/280

(57) ABSTRACT

A non-helical, multiple compound element, true torsion system includes a working element to be connected to a load, an adjustable control element and a drive for driving the control element. At least one S-shaped compound torsion element has ends each being connected to a respective one of the working and control elements.

### BACKGROUND OF THE INVENTION

1. Field of the Invention

The invention relates to a non-helical, multiple compound element, true torsion system, for connection between a drive and a load.

2. Description of the Related Art

Non-helical true torsion springs or rods are limited in their rotational range, load capacity and efficiency by the rapid increase of internal molecular stresses within the torsion elements. Internal stresses increase exponentially at the doubling of the elements' radius or its rotation in degrees, causing rapid loss of efficiency, resistance to further rotation and deformation or failure of the element. Rotationally used helical or coiled springs, commonly mislabeled as torsion devices, increase their usable rotation range by having very long, small diameter coiled elements, like garage door springs. The difficult-to-use configuration or shape requires the elements be used in the much less efficient tension-compression or non-torsion mode and sacrifice load capacity, ease of use and efficiency.

U.S. Pat. No. 6,877,728 discloses a suspension assembly having multiple torsion members which are not twisted in torsion. Elastomeric material between first and second revolving members is distorted by rotation of one member within the other.

U.S. Pat. No. 5,161,818 teaches a lateral compound torsion suspension device using return bars, which are not complementary but instead exert forces or torsion in opposite vectors. The device is folded in layout only and the capacities of the torsion elements are not added. There are separate connections of the load carrying torsion and anti-sway torsion regulating systems.

U.S. Pat. No. 6,752,411 shows a two-piece, rigid axle having two elements which are elastomeric and not in torsion. A unit rotates but there is no twisting or torsion. Resistance or energy absorption is accomplished through elastomeric squeezing.

U.S. Pat. No. 5,277,450 discloses a torsion axle in which a primary torsion axle 48 operates in simple torsion and a load level is adjusted by controlling the compressibility of elastomeric rods. Rather than providing a multistage device using two torsion units, one torsion unit and one elastomeric adjustable base or reference unit are provided. They are not compound torsion devices.

U.S. Pat. No. 5,178,406 teaches a torsion bar system which does not carry a vehicle load, but instead torsion is used for sway control. As the vehicle attempts to sway and roll, the bar picks up an inside wheel.

U.S. Pat. No. 5,163,701 shows a torsion spring vehicle suspension having a torsion cartridge inserted inside an axle and a load carried through a torque hub and shaft. Only the torsion cartridge and not the axle is in torsion. The device is non-adjustable and is limited in rotation and not compound in nature.

U.S. Pat. No. 6,241,224 discloses a torsion spring in which first and second members absorb rotational forces, not by torsion of an element but by elastomeric compression of rubber-like material therebetween.

### SUMMARY OF THE INVENTION

It is accordingly an object of the invention to provide a non-helical, multiple compound element, true torsion system, which overcomes the hereinafore-mentioned disadvantages of the heretofore-known devices of this general type and which provides true torsion, that is a twisting of the molecular structure, not just the act of rotation. True torsion or molecular level twisting of the spring element is much more efficient at absorbing and releasing energy or springing because pure torsion has none of the focused molecular compression as in bending or flexing objects. True torsion spreads tension evenly along the entire element. Multiple compound elements, both load sharing and rotation sharing, create a new class of torsion devices with superior dynamic springing qualities.

With the foregoing and other objects in view there is provided, in accordance with the invention, a non-helical, multiple compound element, true torsion system, comprising a working element to be connected to a load, a non-working, adjustable control element and a drive for driving the control element relative to a fixed base of the drive. At least one or a multiplicity of S-shaped compound torsion elements have ends each being connected to a respective one of the working and control elements. The S-shaped compound torsion element or elements provide the true torsion or twisting of the molecular structure, which is not just rotation. The torsion system, elements and separate parts are manufactured of composite material, metal or other suitable material.

In accordance with another feature of the invention, the at least one S-shaped compound torsion element includes two terminal sections each being connected to a respective one of the working and control elements and an intermediate section connected between the terminal sections, for a total of three sections. However, the torsion system can further include two additional sections each being connected between a respective one of the terminal sections and a respective one of the working and control elements, for a total of five sections. Of course, any number of sections greater than five can also be provided, according to the particular application. Additional compound or folded elements may be added and “connected in series” to increase the rotation capacity by “multi-element serial rotation sharing”. Additional compound or folded elements may also be added and “connected in parallel” to increase load capacity by “multi-element parallel load sharing”. Multiple smaller radius, stress-resistant torsion elements are used in the torsion system instead of larger radius, stress-prone elements to reduce radius induced stresses and increase efficiency.

In accordance with a further feature of the invention, the at least one S-shaped compound torsion element is folded between the sections, or fitments may be used to interconnect the sections. The folds or fitments each provide the necessary connection between the sections. The rotational range of the torsion system (in degrees) may be controlled by the element lengths, torsion characteristics and number of folds or compounding of the formed torsion elements. The load capacity may be statically controlled by the strength, torsion characteristics and number of parallel oriented torsion elements employed.

Therefore, one or more folded elements form compounded torsion elements having at least two termination ends and one or more intermediate ends. The intermediate ends are formed or affixed together by various techniques, causing a reversal of the element structure to create the folded or compounded element. The intermediate ends are locked in torsion to the preceding and succeeding elements to achieve a multi-element continuity of equal torsion sharing between the connected elements. The body of the torsion elements may be bowed or curved for improved clearance or formed of non-parallel wall elements for improved function. The completed torsion elements have a terminal end secured as a fixed, but optionally adjustable attachment to the device or parent structure and the opposing terminal end secured at a moveable working attachment like an arm, lever, pulley or gear. The intermediate element ends, which are not attached to the body of the spring device, have a circular freedom allowing the intermediate ends to rotate in a plane around the axle or axis in shared rotation. Each element's rotational capacity is added to the advancing intermediate points of the next or preceding element. This serial combining or rotation sharing adds the rotation of each element to the moving intermediate points and dramatically increases the total rotation of the elements as a system.

The true torsion spring system according to the invention simultaneously increases load and rotational capacity while still retaining the high efficiency of pure torsion. This compound torsion system reduces internal element radius stress by using multiple, small radius, individually controllable, multi-centric elements placed around a pivoting center or axle for increased “loading in parallel.” The system increases rotational capacity by using serially connected, folded or compounded elements having a cooperative rotation sharing for efficient “rotation in series.”

In accordance with an added feature of the invention, collars each connect a respective one of the terminal sections to a respective one of the working and control elements. At least one of the collars is selectively releasable, permitting rotation of at least one of the terminal sections relative to one of the working and control elements. Others of the collars fix the terminal sections against rotation relative to the working and control elements. The load capacity may additionally be dynamically controlled by the number of torsion elements engaged in the device, such as by their engagement collars, at any one time. The element engagement collars may be engaged or released manually or electrically whether the device is without spring load or in torsion. The working end attachment points' rotational position and preload may be controlled statically or dynamically, by the rotational adjustability of the fixed end attachment.

The attachment of the element terminal ends to the device endplates allows lengthwise and angulation movements of all elements and may be optionally set to lock or free rotation movement between each individual element and its attachment point to augment function and control torsion loading. The device's attached or non-working endplate may be adjusted or turned in rotation to adjust, increase or decrease torsion on the element group.

In accordance with an additional feature of the invention, the control element is a gearwheel, and the drive is a motor having a shaft with teeth meshing with the gearwheel. An axle passes through the working and control elements to the mounting stands. A working wheel or arm is connected to the axle in the vicinity of the working element.

In accordance with yet another feature of the invention, at least one servo device or motor engages and releases at least one of the collars. An electronic control device actuates the at least one servo device. At least one sensor may be connected to the electronic control device for sensing load variations to be used for actuating the at least one servo device. The electronic control device may have a program for actuating the at least one servo device. The electronic control device may be connected to the drive for driving the control element.

In accordance with a concomitant feature of the invention, the load is a vehicle suspension member and the control element is connected to a frame or chassis of a vehicle. Alternatively, the load is a door, such as a garage door, and the control element is connected to a building structure. Of course, the load may be any sprung device having a chassis and said control element may be connected to the chassis.

Other features which are considered as characteristic for the invention are set forth in the appended claims.

Although the invention is illustrated and described herein as embodied in a non-helical, multiple compound element, true torsion system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a diagrammatic, front-elevational view of the non-helical, multiple compound element, true torsion system according to the invention;

FIG. 2 is a top-plan view of the true torsion system;

FIG. 3 is a top and control-end perspective view of the true torsion system;

FIG. 4 is an enlarged, top and control-end perspective view of the true torsion system with several elements removed;

FIG. 5 is a front-elevational view of the true torsion system shown in FIG. 4;

FIG. 6A is a front-elevational view of a single section of a torsion element, FIGS. 6B, 6C and 6D are front-elevational views of a torsion element of the true torsion system with multiple sections and FIG. 6E is a front-elevational view of an external bonding fitment therefor;

FIG. 7 is a further enlarged, end-elevational view of an element of the true torsion system;

FIG. 8 is a perspective view of the element of the true torsion system shown in FIG. 7, in torsion;

FIG. 9A is a front-elevational view of a single section of a torsion element and FIGS. 9B, 9C and 9D are respective front-elevational, end-elevational and perspective views of a torsion element of the true torsion system with multiple sections;

FIG. 10 is an enlarged, fragmentary, working-end perspective view of the true torsion system; and

FIG. 11 is an enlarged, fragmentary, control-end perspective view of the true torsion system.

### DESCRIPTION OF THE PREFERRED EMBODIMENTS

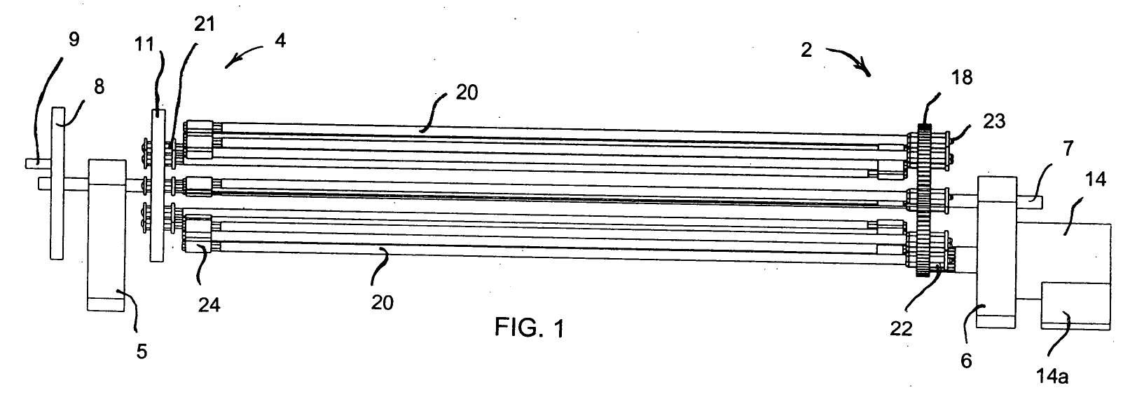

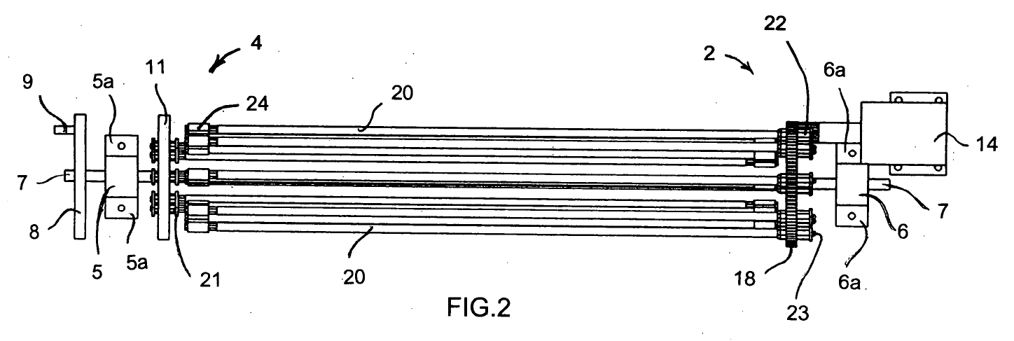

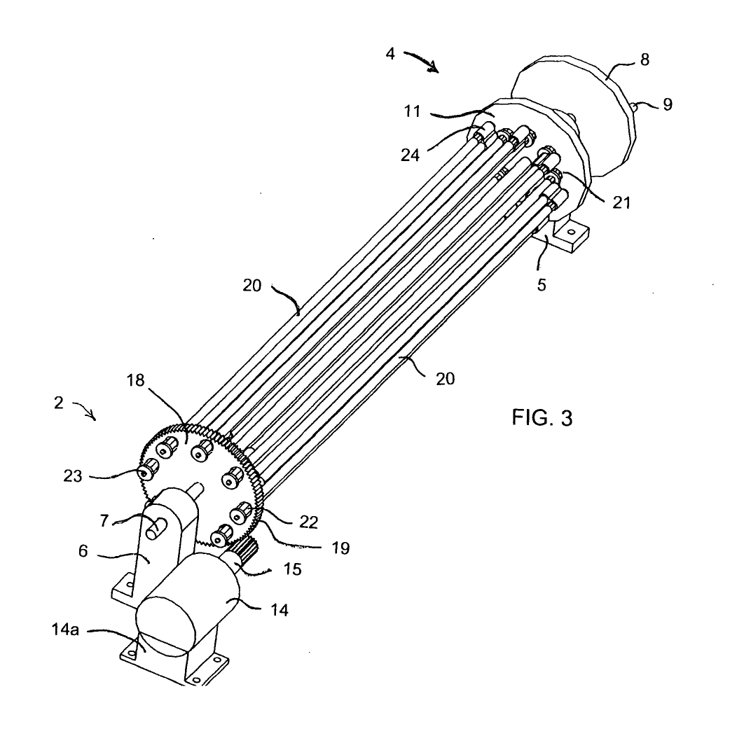

Referring now to the figures of the drawings in detail and first, particularly, to FIGS. 1-3 thereof, there is seen a non-helical, multiple compound element, true torsion system according to the invention, having an attached, affixed, adjustable control end 2 and a working or load end 4. The system is supported on mounting stands 5, 6 through which a device axle 7 passes. The mounting stands 5, 6 have respective bases 5a, 6a with holes formed therein for securing the mounting stands to a surface. As is seen at the working end 4, a working wheel or working arm 8, which is mounted on the device axle 7 outside of the mounting stand 5, has a stub 9 eccentrically protruding therefrom for connection to a load. A working element, in the form of a working end plate 11, is mounted on the device axle 7 inside of the mounting stand 5, that is toward the control end 2. As is seen at the control end 2, a manual or servo driver 14 is disposed outside or alongside of the mounting stand 6 on a base 14a having holes formed therein for securing the driver 14 to a surface. The driver 14, which may be an electric motor or be driven by a hand crank, has a shaft 15 with gear teeth 16 formed at the end thereof. A control element, in the form of a control-end, adjustable end plate 18, is mounted on the device axle 7 inside of the mounting stand 6, that is toward the working end 4. The adjustable end plate 18 has gear teeth 19 meshing with the gear teeth 16.

The load connected to the working wheel or working arm 8 may be a vehicle suspension member and the control element 18 may be connected to a frame or chassis of a vehicle. The load connected to the working wheel or working arm 8 may also be a door, such as a garage door, and the control element 18 may be connected to a building structure. Individual torsion elements, which are identified generally by reference numeral 20, are connected between the working end plate 11 and the adjustable control end plate 18. The torsion elements 20 are connected to the working end plate 11 by element collars 21 and are connected to the adjustable end plate 18 by element attachment collars 22. The element attachment collars 22 have release buttons 23 which may be pushed-in for disengagement of the torsion elements 20 by sliding out from the adjustable end plate 18. Such release buttons could also be provided for the collars 21 as well.

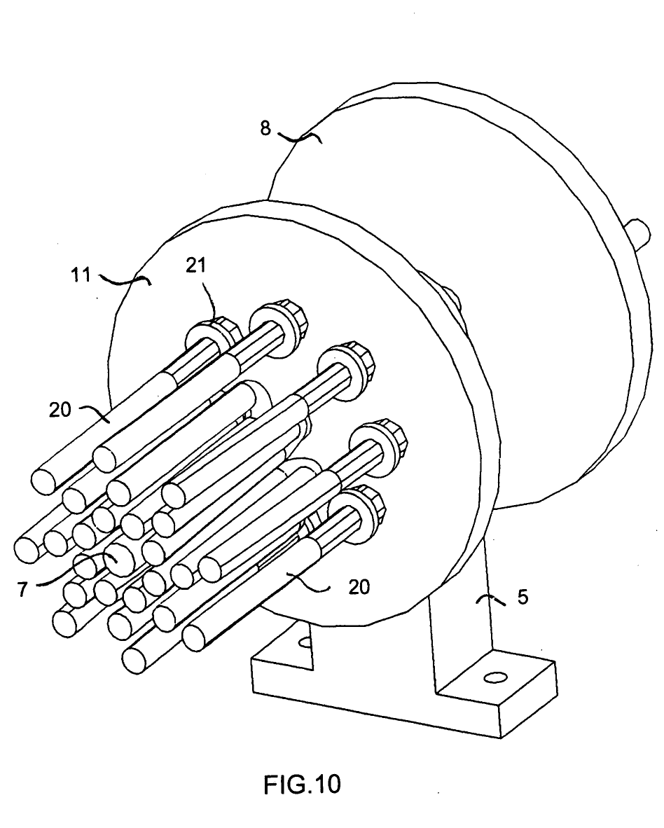

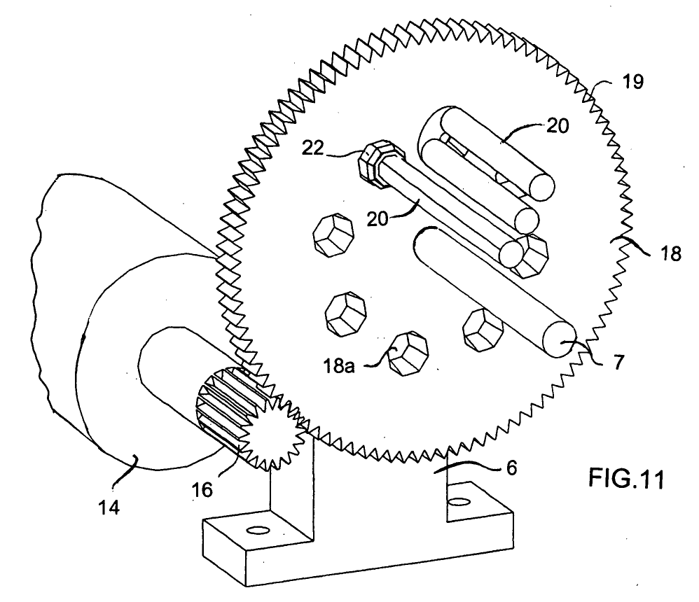

FIGS. 10 and 11 are enlarged to more clearly show the connection of the torsion elements 20 to the working end plate 11 by the element collars 21 and to the adjustable end plate 18 by the element attachment collars 22. FIG. 11, in particular, shows that the end plate 18 has holes 18a formed therein having polygonal surfaces for receiving the attachment collars 22 which have polygonal outer surfaces, as shown.

The torsion elements 20, which may be formed of composite material, metal or any other suitable material, may be individually adjusted manually or with servomotors so as to be fixed or freely rotatable at the end plates 11, 18, as needed to provide the desired total torsion of all of the torsion elements 20 for a particular application. Accordingly, some torsion elements 20 may be fixed at both ends, some may be freely rotatable at both ends and some may be fixed at one end and rotatable at the other, all within one system.

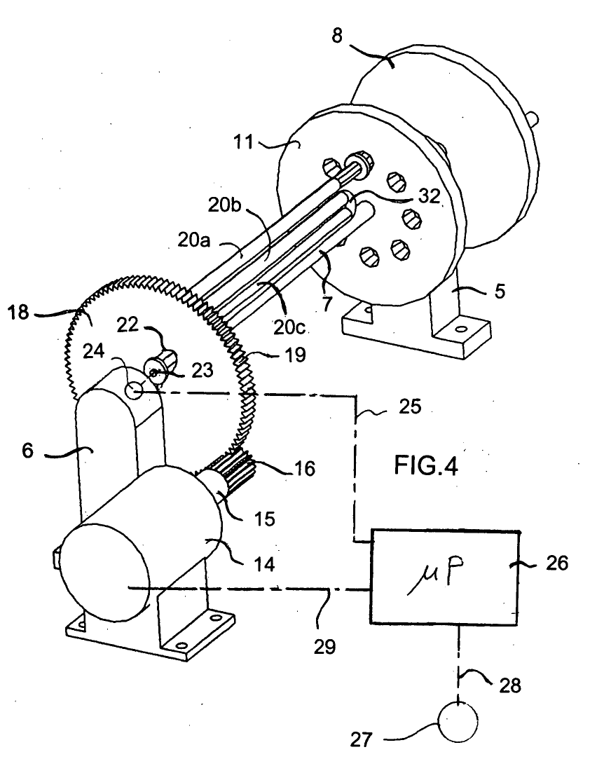

The adjustment is carried out by activating the release buttons 23, as mentioned above. This may be effected manually or with servo devices or servomotors 24, only one of which is shown in FIG. 4 for the sake of clarity. The servomotors 24 are connected over a line 25 to an electronic control device or panel 26 having a microprocessor μP, such on the dashboard of a vehicle. The electronic control device or panel 26 may have manual switches for adjusting load compensation by a driver of a vehicle contemplating the need for such an adjustment. Remote control can also be effected wirelessly. The servomotors may also be controlled individually or in groups according to a control program in the microprocessor μP based on an actual or expected change in vehicle loading. Sensors 27 may also communicate over lines 28 with the microprocessor μP so as to activate one or more of the servomotors 24 based on a change in load detected by the sensors 27. The sensors 27 may be placed in various locations throughout a vehicle or other load so that the torsion control may automatically adjust the torsion in different locations for uneven loads. Elements 22-28 are therefore part of the torsion control for adjusting torsion in the torsion elements 20. The electronic control panel 26 is also connected to the servo driver 14 over a line 29. Therefore, load requirements detected by the sensor 27 or input manually into the electronic control panel 26, such as by a driver of a vehicle, adjust the attachment collars 22 by activating the buttons 23 and cause the servomotor 14 to rotate the end plate 18 for producing the desired torsion at the working wheel or arm 8. Of course, for applications such as a garage door, the setting of the attachment collars 22 may be effected once upon installation without the need for change at a later date since the load never changes.

After adjusting the torsion elements 20 to be fixed or rotatable, the manual or servo driver 14 turns the shaft 15 which in turn turns the end plate 18 to apply the desired torsion to the torsion elements 20 and thus to the entire system at the control end 2. The torsion is delivered at the working end 4 to the end plate 11. Although the end plate 11 is shown as a wheel having an eccentric stub 9 for delivering the torsion, it may have an arm, a pulley or a gear, etc. instead, depending on the application, such as for a garage door or an automobile, etc.

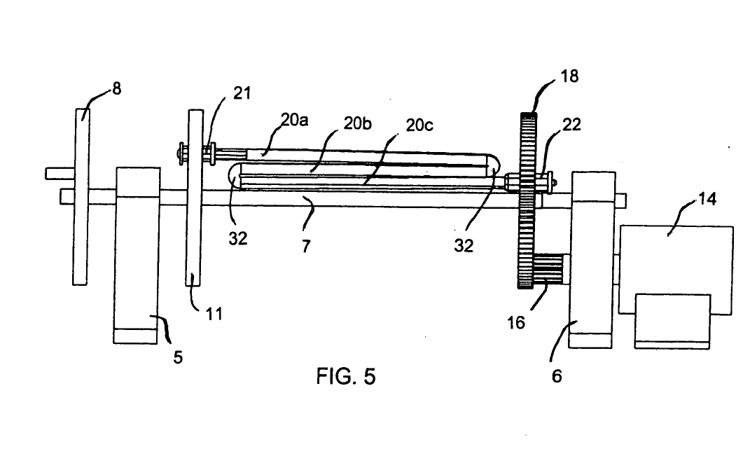

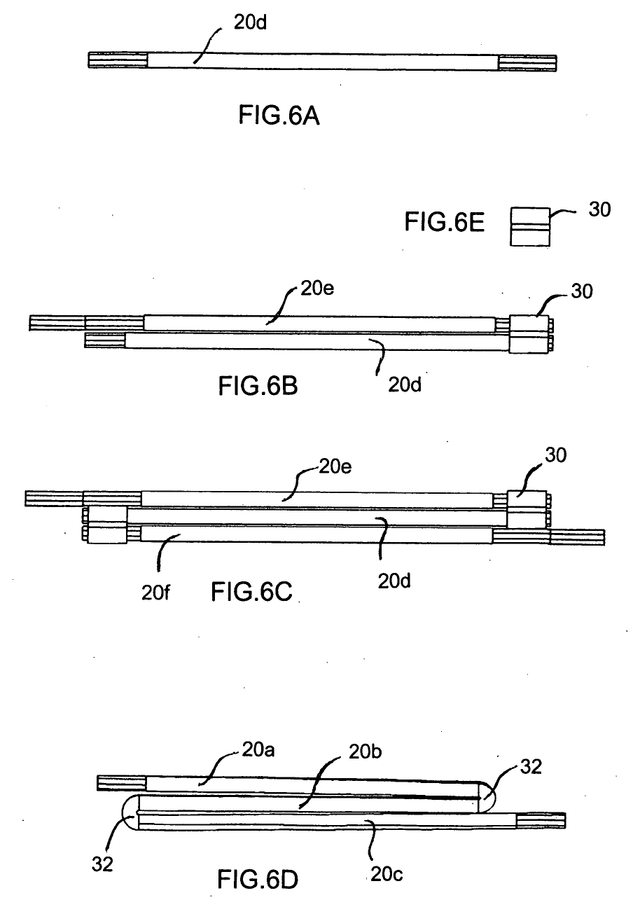

It may be seen with the aid of FIGS. 4 and 5 that the torsion elements 20 may be folded back on themselves twice at folds 32 so that they are S-shaped and have three sections, that is terminal sections 20a and 20c each being connected to a respective one of the element collars 21, 22, and an intermediate section 20b therebetween, to form a unified compound torsion element. Such an S-shaped folded compound torsion element having sections 20a, 20b, 20c and folds 32 is also shown in FIG. 6D.

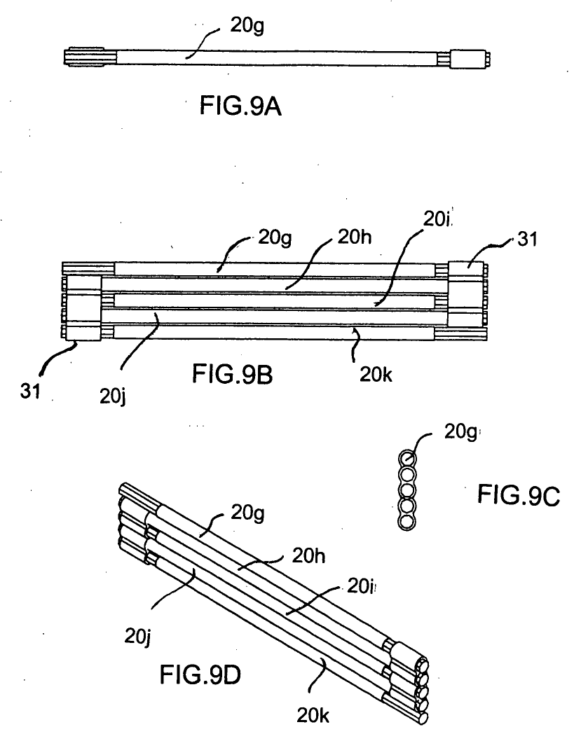

In contrast, FIG. 6A shows a single section 20d and FIG. 6B shows two sections 20d and 20e, to be used in a compound torsion element having three sections 20d, 20e and 20f as shown in FIG. 6C. The three sections are interconnected by fitments 30 each bonding two respective sections. Similarly, FIG. 9A shows a single section 20g to be used in a compound torsion element shown in FIGS. 9B, 9C and 9D. Each of FIGS. 9B, 9C and 9D show a compound torsion element having five sections 20g-20k interconnected by fitments 31 each bonding three sections. The compound torsion element having five sections may be described as an S-shaped compound torsion element having sections 20h, 20i and 20j, to which two additional sections (20g, 20k) are each connected.

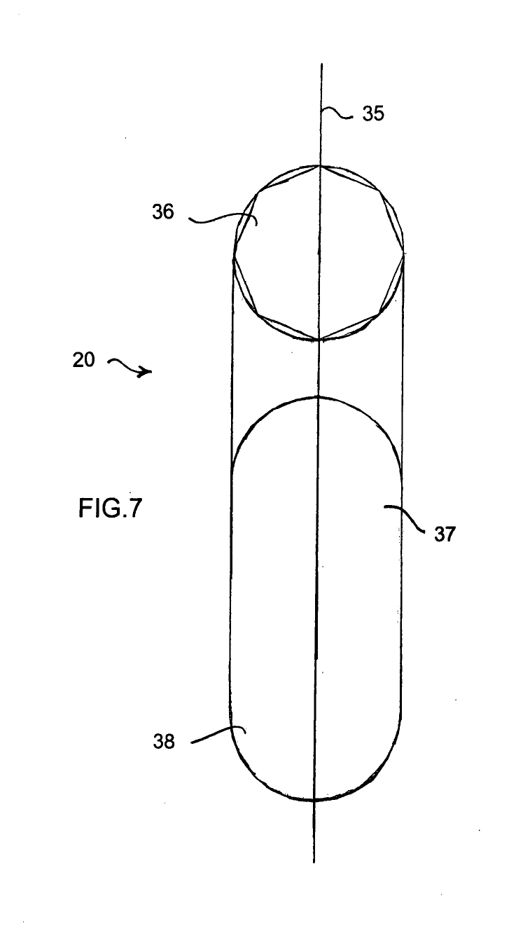

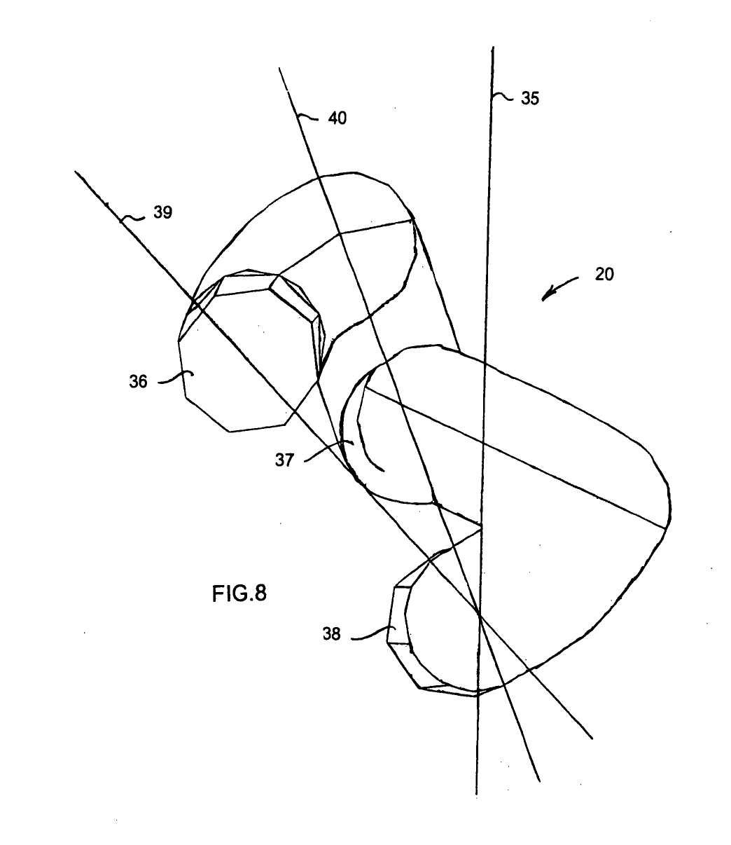

FIGS. 7 and 8 are greatly enlarged views of a torsion element 20 for illustrating the effect of the torsion produced according to the invention. FIG. 7 shows the torsion element 20 before torsion is applied, having a zero axis 35, a working terminal end 36 with zero rotation, an intermediate end 37 with zero displacement and a fixed terminal end 38. As can be seen from FIG. 8, when torsion is applied, the torsion element 20 moves out of the zero axis 35 and undergoes a rotation of the terminal end 38 and a shared translation or rotation of the intermediate end 37, along respective axes 39, 40 as shown.

I claim:

1. A non-helical, multiple compound element, true torsion system, comprising:
a working element to be connected to a load;
a control element;
a drive for driving said control element; and
at least one S-shaped compound torsion element having ends each being connected to a respective one of said working and control elements.

2. The torsion system according to claim 1, wherein said at least one S-shaped compound torsion element includes a multiplicity of S-shaped compound torsion elements having ends each being connected to a respective one of said working and control elements.

3. The torsion system according to claim 1, wherein said at least one S-shaped compound torsion element includes two terminal sections each being connected to a respective one of said working and control elements and an intermediate section connected between said terminal sections.

4. The torsion system according to claim 3, which further comprises two additional sections each being connected between a respective one of said terminal sections and a respective one of said working and control elements.

5. The torsion system according to claim 3, wherein said at least one S-shaped compound torsion element is folded between said sections.

6. The torsion system according to claim 3, which further comprises fitments interconnecting said sections.

7. The torsion system according to claim 3, which further comprises collars each connecting a respective one of said terminal sections to a respective one of said working and control elements.

8. The torsion system according to claim 7, wherein at least one of said collars is releasable permitting rotation of at least one of said terminal sections relative to one of said working and control elements, and others of said collars fix said terminal sections against rotation relative to said working and control elements.

9. The torsion system according to claim 1, wherein said control element is a gearwheel, and said drive is a motor having a shaft with teeth meshing with said gearwheel.

10. The torsion system according to claim 1, which further comprises mounting stands and an axle passing through said working and control elements to said mounting stands.

11. The torsion system according to claim 1, which further comprises a working wheel or arm connected to said axle in vicinity of said working element.

12. The torsion system according to claim 7, which further comprises at least one manual or servo device for engaging and releasing at least one of said collars, and an electronic control device for actuating said at least one servo device.

13. The torsion system according to claim 12, which further comprises at least one sensor connected to said electronic control device for sensing load variations to be used for actuating said at least one servo device.

14. The torsion system according to claim 12, wherein said electronic control device has a program for actuating said at least one servo device.

15. The torsion system according to claim 12, wherein said electronic control device is connected to said drive for driving said control element.

16. The torsion system according to claim 13, wherein said electronic control device is connected to said drive for driving said control element.

17. The torsion system according to claim 1, wherein the load is a vehicle suspension member and said control element is connected to a frame or chassis of a vehicle.

18. The torsion system according to claim 1, wherein the load is a door and said control element is connected to a building structure.

19. The torsion system according to claim 1, wherein said at least one S-shaped compound torsion element is formed of a material selected from the group consisting of composite material and metal.

20. The torsion system according to claim 1, wherein said at least one S-shaped compound torsion element is bowed or curved for improved clearance or formed of non-parallel wall elements.

21. The torsion system according to claim 1, wherein the load is a sprung device having a chassis and said control element is connected to said chassis.
